(19) United States
(12) Patent Application Publication
(10) Pub. No.: US 2013/0016344 A1
(43) Pub. Date: Jan. 17, 2013

(54) Method and Apparatus for Measuring Process Parameters of a Plasma Etch Process

(71) Applicants: Larry Bullock, Arlington, TX (US); Andrew Weeks Kueny, Dallas, TX (US); Mark Anthony Meloni, The Colony, TX (US)

(72) Inventors: Larry Bullock, Arlington, TX (US); Andrew Weeks Kueny, Dallas, TX (US); Mark Anthony Meloni, The Colony, TX (US)

(21) Appl. No.: 13/183,240

(22) Filed: Jul. 14, 2011

(51) Int. Cl. G01J 1/34

(52) U.S. Cl. 356/217

(57) ABSTRACT

A configurable hybrid superheterodyne spectrum analyzer for deriving process state parameters from detected modulated light emitted by a plasma receives and conditions the electric signals converted from the modulated light for subsequent superheterodyne mixing at a specific intermediate frequency (IF) that is lower than the frequency of the modulated light. Signal conditioning includes filtering noise, aliasing and DC and/or amplifying or de-amplifying the signal. Once mixed, the superheterodyne signal is further filtered by an IF filter to define the signal bandwidth characteristics relevant to the process state parameters. The IF filter may configurably employ multiple filter functions such as Gaussian filtering of increasing widths and/or comb filtering for multiple passbands in the frequency spectrum. Finally, the IF mixed and filtered signal is digitized with respect to the specific intermediate frequency using an IF digitizer. The processed signal is then passed to a signal analyzer for derivation of process state parameters. The system may further include a controller for receiving information from the signal analyzer regarding signal processing requirements and then actively configuring one or all of the signal conditioner filter, signal conditioner amplifier, IF filter and IF digitizer to meet those requirements.

### CROSS REFERENCES TO RELATED APPLICATIONS

The present application is related to the following co-pending U.S. patent application: U.S. patent application entitled, “Method and Apparatus for Measuring Process Parameters of a Plasma Etch Process”, having application Ser. No. 12/524,855, and with PCT filing date of filed Jan. 31, 2008, currently pending, which is assigned to the assignee of the present invention. The above identified application is incorporated by reference herein in its entirety.

### BACKGROUND OF THE INVENTION

The present invention relates generally to the monitoring of plasma etch processes. More particularly, the invention relates to a method and an apparatus for determining one or more process parameters of a plasma etching process occurring on a workpiece such as a semiconductor wafer. These process parameters may be indicative of the process state of the workpiece or may be indicative of the process state of the plasma environment or process tool. Process parameters associated with a workpiece may include etch rate, etch depth, layer transition and endpoint of the etching process. Process parameters associated with the plasma environment may include plasma sheath conditions, faults, arcing and instability. Process parameters associated with the process tool may include faults, gas flow variability and gas pressures. Other process parameters and process state variables are also known and may be determined. These parameters may be utilized in-situ for real-time plasma etch process control.

Plasma etching is one of the primary processes involved in semiconductor manufacturing. A typical plasma etch process utilizes a plasma discharge to remove exposed regions of a patterned layer of material on a semiconductor wafer surface. The wafer may include multiple layers and one or more of the layers may be etched during a single plasma etch process. A common plasma etch process is shallow trench isolation where trenches are etched into patterned silicon. A second common plasma etch process is any of a number of line or via etches required for dual damascene copper interconnect processing.

A number of types of plasma etch process tools are utilized in the semiconductor industry. A commonly used type of plasma etching reactor is the Capacitively Coupled Plasma (“CCP”) reactor. Other types of plasma etching reactors include the Inductively Coupled Plasma (“ICP”) reactor and the Radial Line Slot Array (“RLSA”) reactor. Each of these reactor types produces different effects on the measurement of plasma parameters due to primary frequency, secondary frequencies, harmonics, power oscillation and magnetic “plasma stirring,” all of these can modify the chemical and electromagnetic conditions within the plasma and therefore affect the time series of any measured plasma parameter data whereby affecting any determined process parameters.

FIG. 1 shows a cross-sectional pictorial schematic of simplified CCP plasma etch reactor 100. Vacuum chamber 105 of plasma etch reactor 100 encloses bottom electrode 110, on which workpiece 120 may be placed, and top electrode 130. Gas inlet 140 and exhaust line 145 are provided though the wall of vacuum chamber 105 to permit the entry and exit of fresh and used process gases, respectively. Radio frequency (“RF”) power, supplied to excite plasma 150, is coupled across plasma 150 and workpiece 120 from RF power supply 160 to bottom electrode 110 through plasma 150 to top electrode 130. The plasma etch process results in the removal of material from workpiece 120 by plasma driven processes such as sputtering, chemical etching or reactive ion etching. The removed material, etch-by-products 155, is often transported or volatized into the plasma 150. Etch-by-products 155 (indicated as vertical arrows entering plasma 150) and the process gases contribute to the chemistry of plasma 150 and modify the plasma parameters.

As detailed in U.S. patent application Ser. No. 12/524,855 multiple methods for monitoring plasma and/or wafer process parameters are in use. Prior art described methods therein include optical emission spectroscopy, laser reflectometry and white light reflectometry. These methods often include expensive and/or complex integration into plasma etch reactors. Issues with these method include lack of sufficient signal-to-noise (“S/N”) and sensitivity to workpiece size due to fixed spot sizes.

U.S. patent application Ser. No. 12/524,855 describes systems for monitoring plasma parameters by detecting modulated light emitted by the plasma. For example, as shown in FIG. 1, modulated light 170 is detected by sensor 175 positioned on a side viewport of vacuum chamber 105. As described therein, changes in the plasma chemistry may result in modifications in the modulated light emissions from the plasma. For example, when a change of material composition is exposed upon a workpiece surface by the action of the plasma etching, the etch-by-products will cause a change in the chemistry of the plasma and modify plasma parameters therefore altering the modulated light emissions. This chemical change may also affect the RF power levels, RF matching network settings, gas pressure and non-modulated optical emission from the plasma.

The systems described in U.S. patent application Ser. No. 12/524,855 for monitoring plasma parameters, by isolating the RF-modulated plasma emissions from any non-modulated emission, may provide cost and performance benefits over other techniques such as optical emission spectroscopy. However, further improvements as described herein below are necessary to accommodate advancements in the technology and practice of plasma etching processes.

### BRIEF SUMMARY OF THE INVENTION

The present invention is directed to a system, method and software product for deriving process state parameters from modulated light detected from plasma emissions, from a plasma produced in, for instance, a semiconductor etch process. There, etch by-products will cause a change in the chemistry of the plasma and modify certain plasma parameters that may also affect the plasma light, particularly a modulated light component of the plasma emissions

A semiconductor wafer is plasma etched in a reactor with a viewport window for observing the plasma emissions. Typically, the plasma light is optically filtered using a filter based on the detectable modulated wavelengths of the emitted plasma light that may be related to the process state parameters to be derived. Once the plasma light is filtered, it is received by an optical sensor that converts the spectral light intensities to electrical light signals. Those electrical light signals are then received by a signal processor which further processes the light signals with respect to the modulated wavelengths that are related to the process state parameters to be derived. The processed light signals can then be evaluated for plasma parameters and/or process state information that may be used to determine an endpoint for the etch process, a threshold value or slope of the time series data or other parameter that provides information concerning the state of a production process, a semiconductor wafer, the reactor or reactor chamber or faults or general health of the system.

In accordance with one embodiment of the configurable hybrid superheterodyne spectrum analyzer for deriving process state parameters, modulated light emitted by the plasma is extremely useful for deriving pertinent process parameters that are highly indicative of process states, semiconductor wafer production states, the reactor or reactor chamber, process faults or the general health of the system. Therefore, the presently described invention utilizes a signal processor with superheterodyne functionality for scanning and down-converting the frequency of the modulated light signal to facilitate processing by subsequent signal processing elements with respect to the frequency of the modulated light signal. Hence, the resultant processed light signal is highly optimized for frequencies related to the process parameters to be derived.

Prior to superheterodyne mixing, the light signals are conditioned for further analog and/or digital processing by one or both of a conditioning filter and low noise amplifier. The conditioning filter may be a lowpass, highpass or bandpass analog filter, which may have a fixed filter function or may be programmable. Additionally, the filter may be actively configurable for altering filter parameters on the fly in response to receiving control signals from a controller. The low noise amplifier adjusts the intensity of the modulated light detected by the optical sensor within a range that is optimally suited to an input signal range of an intermediate frequency filter (“IF”) digitizer (discussed below). Low noise amplifier may passively used to adjust the gain imposed on the light signal prior to digitization, or similar to the conditioning filter discussed above, may actively adjust the gain of the light signal based on instructions from the controller.

Once the modulated light signal is conditioned, the signal is superheterodyned with an intermediate frequency, the intermediate frequency mixing converts the modulated signal to a fixed and lower intermediate frequency, which can be more conveniently processed. Optimally, the superheterodyne mixer utilizes an intermediate frequency mix signal derived from voltage controlled oscillator that receives a phase-locked-looped (PLL) reference frequency from an oscillator. The oscillator can also provide a reference for any other IF components needing an intermediate frequency reference.

The superheterodyne mixed intermediate frequency signal is then filtered by an intermediate frequency filter to define the signal bandwidth characteristics conducive to deriving process state parameters from a modulated light prior to digitization. The IF filter may provide filter functions of increasing widths to aid isolation process parameters indicative of the process state, comb filtering for multiple passbands in the frequency spectrum, or may employ multiple filter functions such as Gaussian and comb filter functions in order isolate various harmonics associated with the modulated light signal.

Once the down-mixed light signal is filtered, an IF digitizer digitizes the signal to produce sampled data for the signal processor or signal analyzer. The IF digitizer operates at the reference intermediate frequency, as provided by the reference oscillator, but under the control of the controller. The controller provides the digitizer with sampling times based on, for instance, timing interval provided by a reference clock. The sample signal data are then transferred to the signal analyzer either directly or through the controller.

Post processing of the sample data may be provided, in addition to that discussed above, via a post processor. Post processing of the sample data may take one of many forms, i.e., FFT, Goertzel algorithms or the like, for instance, to isolate narrow primary bandwidths within the wider filtered and digitized frequency bandwidth.

Because the hybrid superheterodyne spectrum analyzer based plasma parameter measurement system is highly configurable, the controller may alter signal processing parameter for various components on the fly, thus actively change the character of the sampled signal data delivered to the signal processor to facilitate its operation. For example, the signal processor may receive information from the process reactor or other sources indicating that a change is necessary in the sampled data. This change may be relatively insignificant, such as changing the sample rate, or highly significant, such as changing the filter bandwidth to include or exclude portions of the modulated light signal. In any case, the controller receives information from the signal analyzer which in turn communicates with the appropriate signal processing element, for instance, the conditioning filter to alter the filtering parameters, the low noise amplifier to amplify/de-amplify the intensity of the light signal, the IF filter to change the filter function or alter the filter parameters for a current filter function and/or the IF digitizer to alter sample rate.

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of the illustrative embodiments when read in conjunction with the accompanying drawings wherein:

FIG. 1 is a pictorial schematic of a plasma etch reactor;

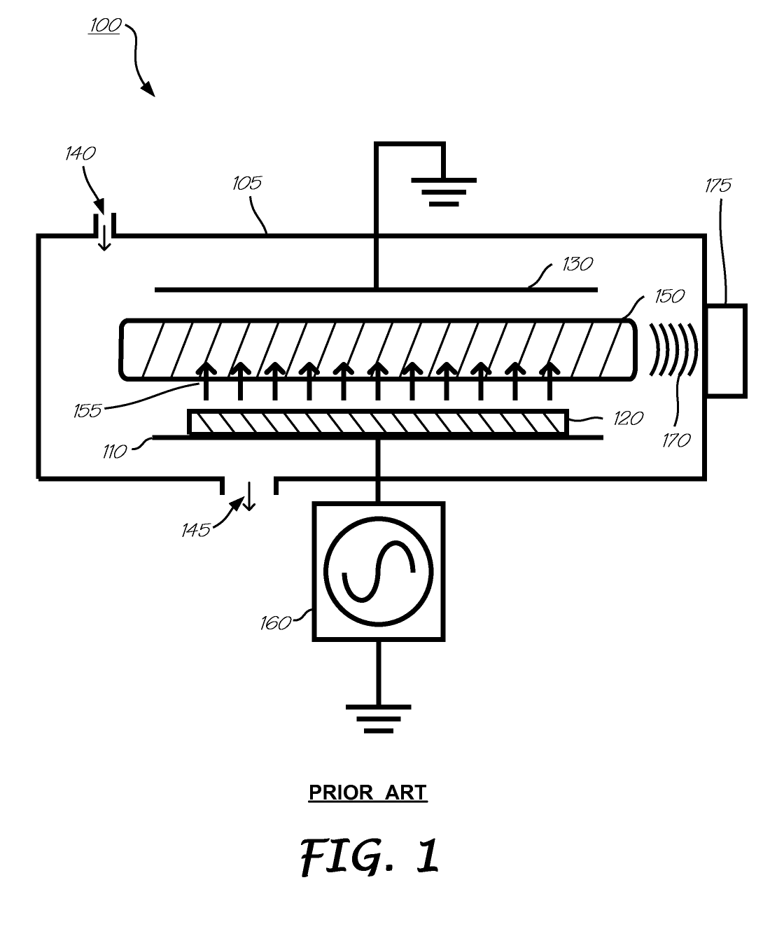

FIG. 2 is a plot of typical plasma excitation frequencies used in plasma etch reactors;

FIG. 3 is a plot of lifetimes of typical gasses used with plasma etch processes;

FIG. 4 is a pictorial schematic of the major elements of a plasma parameter measurement system, in accordance with an exemplary embodiment of the present invention;

FIG. 5 is a pictorial schematic of the major elements of signal processor 430 of FIG. 4, in accordance with an exemplary embodiment of the present invention;

FIG. 6 is a plot of multiple filter functions configurable by IF filter 440 of FIG. 5, in accordance with an exemplary embodiment of the present invention;

FIG. 7 is a plot of comb filter function configurable by IF filter 440 of FIG. 5, in accordance with an exemplary embodiment of the present invention;

FIG. 8 is a flow chart of a process for operating a plasma parameter measurement system, in accordance with an exemplary embodiment of the present invention;

FIG. 9 is a flow chart of a process for detailing measuring step 830 of process 800 of FIG. 8, in accordance with an exemplary embodiment of the present invention; and

FIG. 10 is a flow chart of a process for detailing scanning step 960 of process 900 of FIG. 9, in accordance with an exemplary embodiment of the present invention.

Other features of the present invention will be apparent from the accompanying drawings and from the following detailed description.

### DETAILED DESCRIPTION OF THE INVENTION

In the following description, reference is made to the accompanying drawings that form a part hereof, and that show by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following description is, therefore, not to be taken in a limiting sense. For clarity of exposition, like features shown in the accompanying drawings are indicated with like reference numerals and similar features as shown in alternate embodiments in the drawings are indicated with similar reference numerals.

Prior art systems for monitoring plasma parameters by the detection of modulated light limit the ability to perform multiple desired and/or required plasma parameter measurements for workpieces and/or process reactors and are often non-optimal. Furthermore, the lack of configurability of such prior art systems limits their functionality for in-situ applications on many plasma process reactors due to 1) the significant variability in the frequencies used to excite plasmas; 2) the variability of process gasses used in plasma etch process; and 3) the need to isolate process parameters indicative of the process state of the workpiece, the plasma environment and process reactor from each other.

Additionally, prior art systems collect significant amounts of unnecessary or non-optimal data which complicates data analysis and handling and significantly hinders high speed data collection which limits signal-to-noise and response time for controlling plasma etch processes. To overcome the shortcomings of these prior art systems, the present invention generally includes a system and method for plasma parameter measurements, which increases system performance, configurability, integrability and functionality. Other advantages of the current invention will be described below in association with described embodiments.

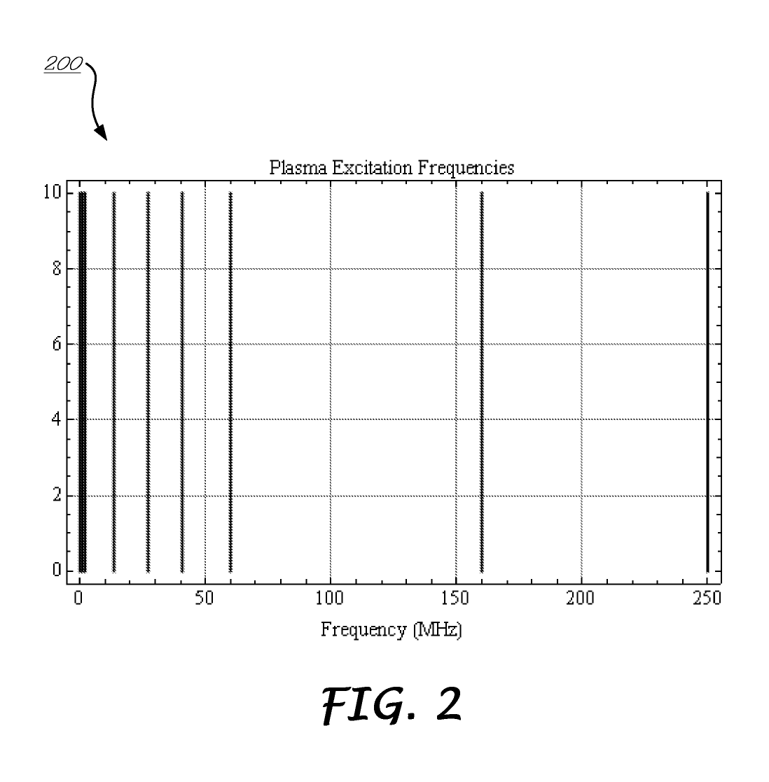

FIG. 2 shows plot 200 of typical plasma excitation frequencies used in plasma etch reactors. As surveyed from RF power supply manufacturers, such as Advanced Energy of Fort Collin, Colo., and other literature; some common plasma excitation frequencies are 0.1, 1, 2, 13.56, 27.12, 40.68, 60, 160, and 250 MHz. Additionally, other plasma excitation frequencies exist at the GHz frequencies, namely 2.4 GHz. As may be seen by inspection of plot 200, there exist large portions of the frequency spectrum where primary excitation frequencies do not exist. Furthermore, it may be common that for any singular frequency such as the common 13.56 MHz, only this primary frequency and its first harmonic at 27.12 MHz are of interest. In other plasma etch reactors, multiple frequency generators may be used; a primary high frequency such as 60 MHz may be utilized with a secondary low frequency such as 2 MHz. One of the frequencies is used to drive the sheath and the second frequency is used to drive the bulk plasma frequency as the ion/radical source. The combination is used by plasma etch reactor manufacturers to optimize process results.

The requirements to sample such high frequencies or such widely varied frequencies places critical demands upon the prior art Fast Fourier Transform (FFT) spectrum analyzer technology. Due to the frequency sampling requirements imposed by the Nyquist limit, the actual sampling frequency must be at least twice as large as the highest desired frequency. Therefore a 60 MHz primary frequency must be sampled at a rate of at least 120 MHz, and higher if the 120 MHz harmonic is of interest. The associated analog-to-digital convertors (“ADC”) with these high sample rate capabilities become prohibitively expensive and electronic designs become subject to burdensome complexity. Due to the limited discrimination capabilities of prior art systems aliasing, frequency resolution and signal-to-noise can also hinder measuring accurate higher quality plasma parameters. Computational and data loads due to typical FFT processing also create large amounts of unnecessary data. For example, to measure plasma parameters associated with a 60 MHz primary plasma excitation frequency and its first harmonic at 120 MHz data must be sampled with a bandwidth of at least 240 MHz, although the necessary bandwidth only include approximately 59-61 MHz and 118-122 MHz for a total of 6 MHz.

Since the frequency resolution of an FFT based spectrum analyzer is determined by the ratio of the sampling frequency and the number of collected samples, in situations where plasma parameters from modulated light driven by widely varied frequencies are monitored, such as a multiple frequency reactor with 60 MHz and 2 MHz, a sampling rate of 120 MHz must be used and a minimum of 1200 samples collected to define a frequency resolution of 0.1 MHz, which provides only 5% (0.1 MHz/2 MHz) resolution sensitivity to any variation on the lower frequency.

Prior art system requires long measurement periods to provide adequate signal-to-noise. Low signal-to-noise of the prior art systems leads to effective single sample measurement times on the order of 10's of milliseconds, which when converted to a time series and analyzed/evaluated to further increase S/N and derive recognizable features of the time series for the determination of a process state parameter, may delay prompt response for necessary real time in situ process control.

Therefore and in accordance with exemplary embodiments of the present invention a modular and configurable hybrid superheterodyne spectrum analyzer based plasma parameter measurement system described herein below mitigates the abovementioned issues with an FFT spectrum analyzer based system and provides operation over a wider frequency range, at highly differing frequencies and at lower cost with higher bandwidth, improved alias rejection and improved signal-to-noise and transient response. Additionally, the system provides highly configurable integration of plasma characteristics to be monitored (frequencies, excited state lifetime, modulated light amplitude, etc.) with wavelength optimized sensors and optical filtering and optimized data collection/processing.

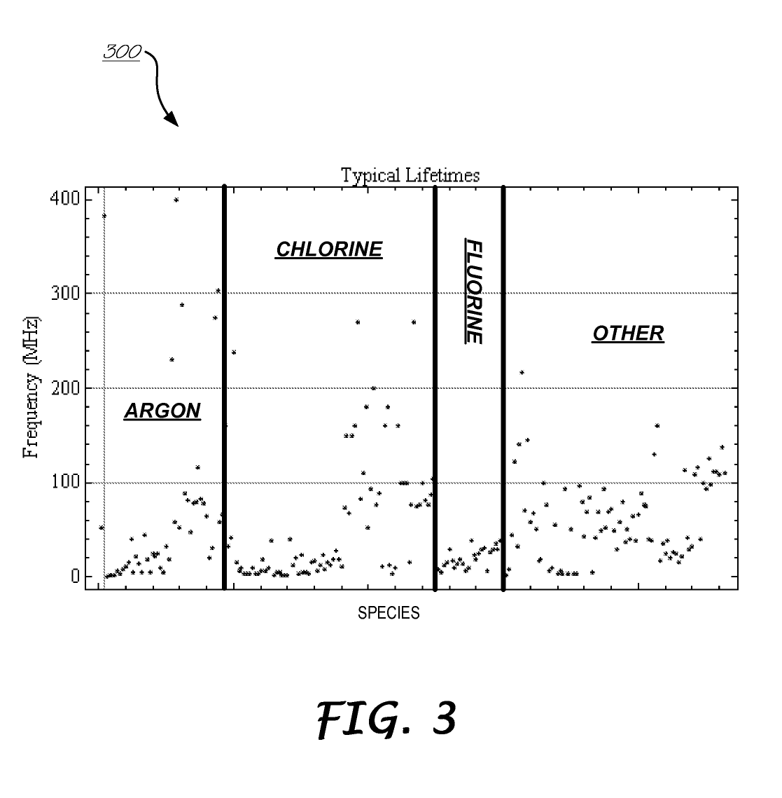

FIG. 3 shows plot 300 of the lifetimes (plotted in reciprocal as frequencies) of a selection of “strong” emission lines of typical gasses used with and/or etch-by-products resulting from plasma etch processes (e.g., Ar, He, Cl, F, O, H, Si, Ti, Ta, Al, C, N). Each plotted point represents a specific spectral line of the noted species and its lifetime. These data were derived from the NIST Atomic Spectra Database available at, for instance, www.nist.gov. As may be seen by comparing the lifetimes of excited states of fluorine with either Argon or Chlorine, it is easily seen that modulated plasma emissions for fluorine may not be observed for excitation frequencies above 50 MHz due to the long lifetimes of the fluorine states. However, argon and chlorine have many excited states that have very short lifetimes and may provide RF plasma driven modulated emissions that are observable above 100 MHz. The association of element excited species with emission wavelength and lifetime provides a key into the use of configurable optical filtering and frequency filtering for optimally selecting the modulations due to selected elements as well as potential understanding of how plasma emission modulation depth may be affected by excited species lifetimes.

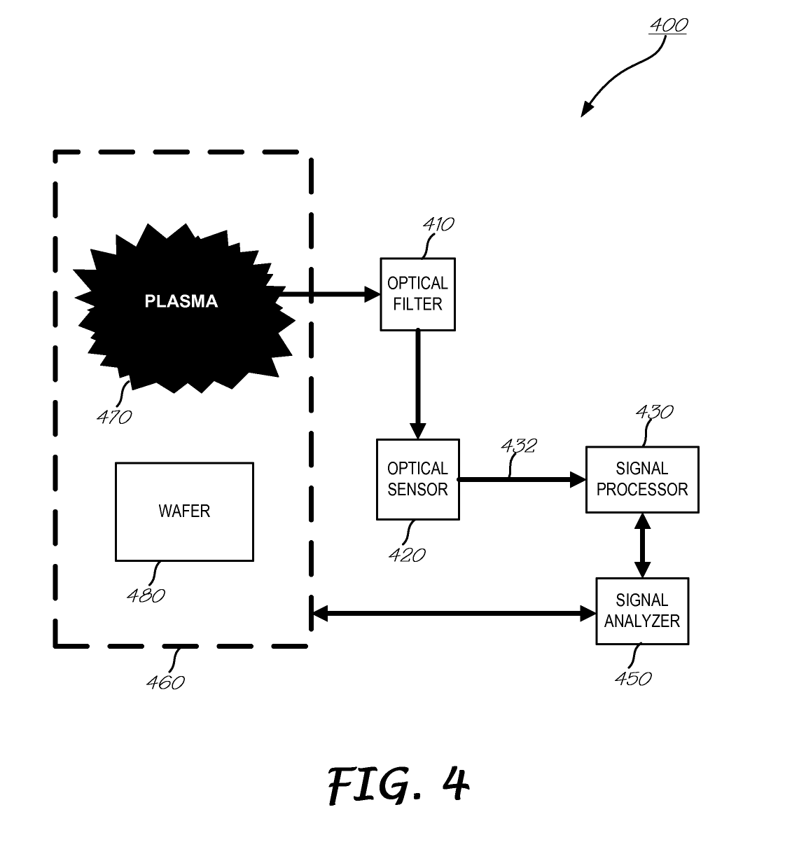

FIG. 4 shows a pictorial schematic of elements of plasma parameter measurement system 400, in accordance with an exemplary embodiment of the present invention. Plasma parameter measurement system 400 includes optical filter 410, optical sensor 420, signal processor 430, and signal analyzer 450. Plasma parameter measurement system 400 is integrated with plasma etch reactor 460 (indicated by dashed lines) to permit observation of modulated light emitted from plasma 470, which is acting to etch workpiece 480.

As mentioned hereinabove, plasma 470 emits modulated light which may carry information related to the process state of workpiece 480, plasma 470 and/or plasma etch reactor 460. As an example of the use of plasma parameter measurement system 400 with plasma etch reactor 460, a simplified version of a commercial silicon dioxide (“SiO₂”) etch using carbon tetrafluoride (“CF₄”) will be discussed, however this exemplary chemistry is not intended to limit the scope of practice of the present invention in any way. In this example, workpiece 480 is a silicon wafer covered with layer of silicon dioxide. The layer of silicon dioxide is most commonly patterned during actual semiconductor manufacturing but this does not alter the discussion herein. Patterning, pattern density and etch uniformity all affect signal-to-noise ratios and are of primary concern for signal optimization of the current invention. State of the art plasma etch processes may be used to etch patterned wafers with pattern densities less than 1%, and pattern densities less than 0.1% are not uncommon. These low pattern densities, by producing very limited amounts of or variation within/among etch-by-products relative to background signals, place stringent requirements on signal-to-noise of signals used for wafer process state determination.

In the exemplary CF₄ plasma etch process, free excited fluorine will be an etch by-product, and its concentration in the plasma will affect the plasma chemistry and, therefore, the modulated light emission. Accordingly, measurements related to fluorine may be used to control the etching process. Typical strong emissions from fluorine include spectral lines at 685.6 nm, 703.7 nm and 712.8 nm with respective lifetimes of approximately 0.02 μs, 0.026 μs and 0.03 μs respectively. When driven by a typical 13.56 MHz frequency plasma with an effective period of 0.074 μs; the fluorine lines should be observable in the modulated light emitted from the plasma. Specifically, the lifetimes of these excited states of fluorine are sufficiently short so as not to significantly attenuate the 13.56 MHz plasma oscillation. Optimization and configuration of the present invention starts with the recognition of these plasma and chemistry parameters and uses these observations to optimize plasma parameter measurement system 400.

Modulated and non-modulated light emitted from plasma 470 may be made available for detection via inclusion of a viewport in the vacuum chamber of the plasma reactor. A viewport may be on a side or a top surface of the vacuum chamber to permit observation of a workpiece, the bulk plasma, the sheath region near the workpiece and/or other region of interest. The modulated light from the plasma may have highest intensity in the region of the plasma bulk to sheath interface. The viewing angle of the sheath is not as critical so long as there is a line of sight to the sheath/plasma interface. Optical filter 410 is located to intercept light exiting from the vacuum chamber and may be placed proximate to the viewport in a housing, free-space coupled away from the viewport or fiber optically coupled to the viewport, depending upon the spatial constraints of the plasma etch reactor, the measurement system and other factors such as temperature and electrical noise. Alternatively, optical filter 410 may be integrated with other elements of plasma parameter measurement system 400 all of which are remote from the viewport.

Optical filter 410 is selected based upon the detectable modulated wavelengths of the emitted plasma light. In this example, since the three named wavelengths should all contribute to the overall intensity of the modulated light, optical filter 410 may be a bandpass filter designed to pass the wavelengths from 685.6-712.8 or may be a singular narrow interference filter for selecting one of the three noted spectral lines. Spectral filters of these types are available from suppliers such as Edmund Optics of Barrington, N.J., USA and Cheshire Optical of Keene, N.H., USA. The careful selection of optical filter 410 not only selects the spectral lines of interest but also rejects out of band modulated and non-modulated light that may interfere with collection and analysis of the light of interest such as by saturating sensor 420. This selection process results in an optimized optical signal (improved S/N by rejection of undesirable light signals) incident upon optical sensor 420. The optical rejection of modulated and non-modulated light may also decrease electrical design requirements such as input signal AC coupling and spectral leakage in the FFT due to the presence of large non-modulated light signals converted by optical sensor 420. FFT spectral leakage may be of specific importance when a second low frequency RF source is used with a primary high frequency RF source. For example, as discussed above for the case of 60 MHz and 2 MHz, limited sampling and therefore limited frequency resolution may result in mixing of non-modulated light data at DC and the 2 MHz modulated light data.

With knowledge of the RF frequency and optical wavelength of interest, optical sensor 420 may be optimally selected for optical-to-electrical conversion efficiency, speed and area, among other factors. For this CF₄ etch process example, optical sensor 420 is selected for use with wavelengths of interest of approximately 700 nm and a RF frequency of 13.56 MHz (assuming that harmonics of the RF frequency are not of interest, the bandwidth of optical sensor 420 need not be larger than approximately 30 MHz.) The area of optical sensor 420 and the size of the observation region of the plasma by optical sensor 420 must be considered as it relates to scaling of the intensity of the detected light signal and the definition of the region of observation within the plasma volume (bulk region, sheath region, wafer region, etc.). Based upon the requirements noted, many types of silicon PIN photodiodes, such as from Hamamatsu Photonics of Hamamatsu, Japan are suitable for and may be optimized for use with plasma parameter measurement system 400. It should be understood that other optical elements (not shown) such as optical fibers, lenses, mirrors, other filters, gratings, windows, homogenizers, etc. may be positioned either/both before or/and after optical filter 410 in the light path to modify aspects of the light incident upon optical sensor 420. Such elements may focus light onto optical sensor 420 or may homogenize light entering optical sensor 420.

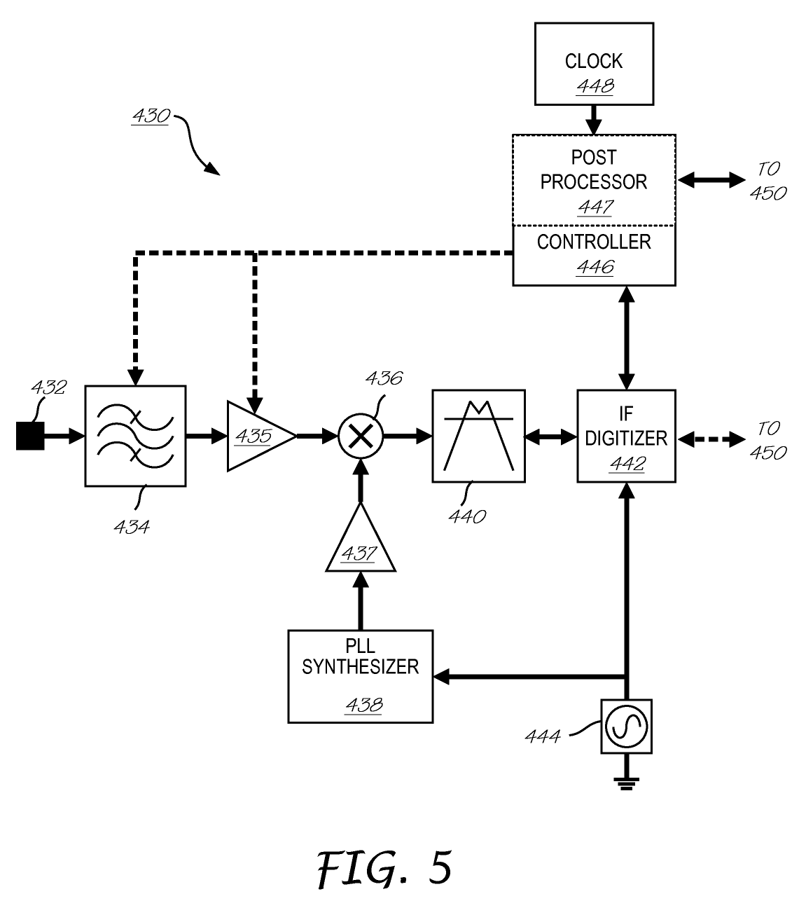

Optical sensor 420 is most often closely electrically coupled to signal processor 430, which as described in detail herein below, in association with FIG. 5, processes electrical signals derived from optical sensor 420 and may filter, amplify, digitize, etc. the derived electrical signals. Once the electrical signals from optical sensor 420 have been processed by signal processor 430 digital data derived from the input electrical signals is sent to signal analyzer 450 for analysis and evaluation to determine plasma parameters and process state information, which may be used as feedback to plasma etch reactor 460 to control plasma 470 or other aspects of the reactor such as gas pressure or flowrate and RF power. For the exemplary CF₄ etch process example, plasma parameters and/or process state information may be used to determine an endpoint for the etch process or to direct process modification by increasing/decreasing the silicon dioxide etch rate. An endpoint for the CF₄ etching of silicon dioxide may be observed in the change in intensity of the modulated light at the fluorine wavelengths, since the CF₄ chemistry etches silicon dioxide differently than silicon, and, therefore, the concentration of fluorine in the plasma will change. It should be mentioned that signal analyzer 450 may also receive information from plasma etch reactor 460 regarding the particular process, type of process or the state of the process, that is passed to signal processor 430 for updating various signal processing parameters used by signal processor 430. This aspect of the presently described invention will become more apparent with the description of signal processor 430 in FIG. 5.

The change in modulated light intensity encoded as a change in the values of the time series data from signal processor 430 may be analyzed by signal analyzer 450 using any of a wide variety of well known mathematical, spectroscopic and chemometric analyses. Signal analyzer 450 may be an industrial computer operating algorithms providing automated analysis of the time series data from signal processor 430 and producing analog or digital signals based upon the analysis for controlling plasma etch reactor 460 or for conveyance to other systems, such as a fab host or data archive system. Signal processor 430 and signal analyzer 450 may be integrated as a single device with the analysis functionality integrated with a digital signal processor (“DSP”), field-programmable gate array (“FPGA”) or other embedded computer processor (Intel Atom™ or PC/104 device) acting as controller 446 (see FIG. 5) as discussed herein below.

In accordance with still another exemplary embodiment of the present configurable hybrid superheterodyne spectrum analyzer based plasma parameter measurement system, the sampled data may be further processed at post processor 447, which may be incorporated within controller 446 as illustrated in the figure. Post processing of the sample data may take one of many forms, i.e., FFT, Goertzel algorithms or the like, for instance, to isolate narrow primary bandwidths within the wider filtered frequency bandwidth.

Alternatively and in addition, the presently described configurable hybrid superheterodyne spectrum analyzer based plasma parameter measurement system may incorporate an actively configurable signal processor for altering, adjusting and/or fine tuning signal processing on the fly. In accordance with this exemplary embodiment of the present invention, signal analyzer 450 not only sends process control signals to plasma etch reactor 460 for controlling the ongoing production process based on the analysis of the time series data produced by signal processor 430 and derived from a modulated component of the plasma emissions produced by the production process, but also sends signal processing configuration instructions to signal processor 430 for modifying its current signal processing parameters. Here, signal processor 430 is dynamically configurable to accommodate changes in the modulated component of the plasma emissions based on process information received by signal analyzer 450 from the plasma etch reactor 460 or the like. The active configurability aspects of the present invention will be better understood through a discussion of signal processor 430 directly below with regard to FIG. 5.

It should be noted that parallelization, serialization and combinations, therefore, are possible for the elements of plasma parameter measurement system 400. For example, multiple optical sensors 420 each with its associated optical filter 410 may be electrically interfaced to a single common signal processor 430 and signal analyzer 450. In another configuration, a variable optical filter or filter wheel may be used in association with a single optical sensor, signal processor and signal analyzer and interlaced measurements of modulated light at different wavelengths may be processed. In a further configuration, multiple sets of a single optical filter, single optical sensor and single signal processor may be associated with a single signal analyzer.

FIG. 5 shows a pictorial schematic of the major elements of signal processor 430 of FIG. 4, in accordance with an exemplary embodiment of the present invention. Signal processor 430 receives as input 432 an electrical signal from optical sensor 420. Input 432 may be modified by filter 434 to condition input 432 for further analog and/or digital processing. Filter 434 may be a lowpass, highpass or bandpass analog filter, which may have a fixed filter function or may be programmable. Filter 434 may be used to remove noise, aliasing or DC bias from input 432. Subsequent to conditioning by filter 434 the signal may be amplified/de-amplified by low noise amplifier 435. Since the intensity of the modulated light detected by optical sensor 420 may vary in intensity, input 432 may not be optimally suited to the input signal range of the intermediate frequency filter (“IF”) digitizer 442. Amplifier 435 may be, therefore, actively or passively used to adjust the gain imposed on the signal prior to digitization. Filter 434 and amplifier 435 may be combined, such as in the ADRF6510, 30 MHz Dual Programmable Filters and Variable Gain Amplifiers available from Analog Devices of Norwood, Mass., USA.

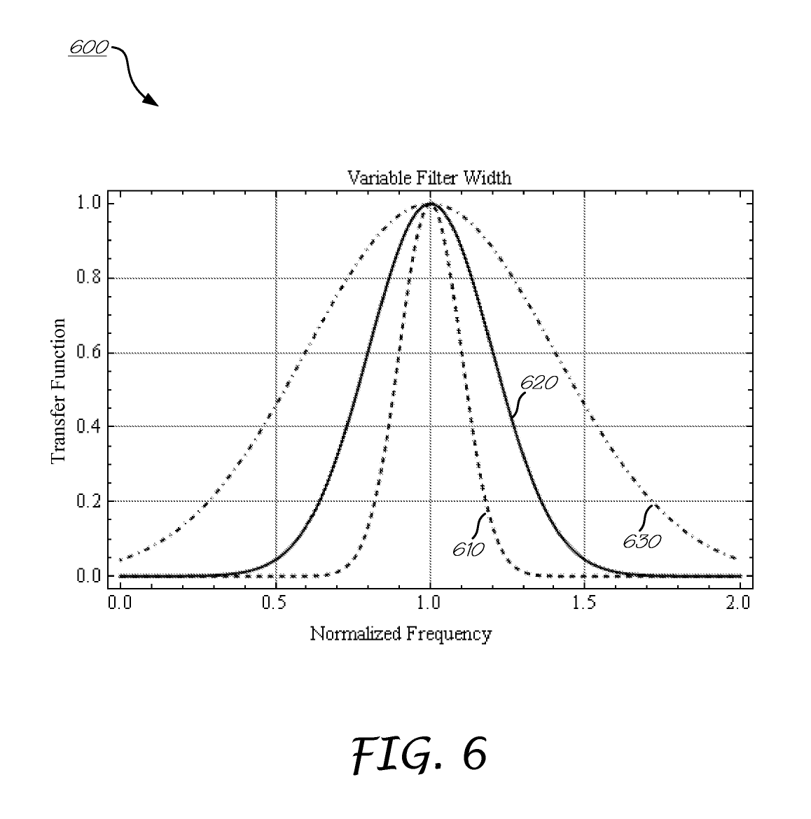

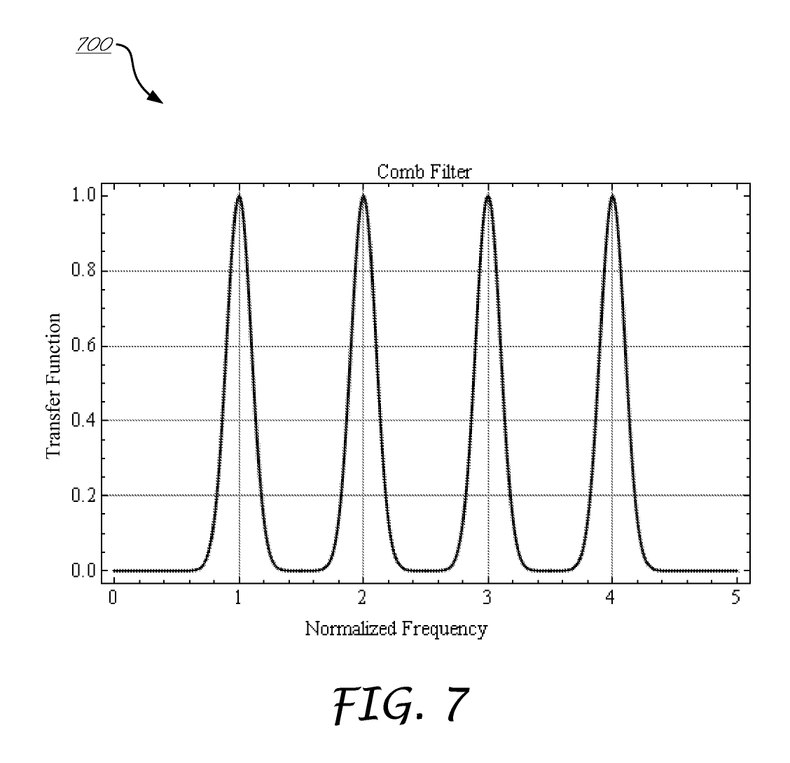

Following filtering and amplification the signal is mixed by mixer 436 with a reference signal derived from voltage controlled oscillator (“VCO”) 437 and phase locked loop (“PLL”) synthesizer 438. Mixer 436 provides the superheterodyne functionality for scanning and down-converting the frequency of the modulated light signals to enable processing by subsequent elements of signal processor 430. PLL and VCO functionality may be provided by a device such as the ADF4252 PLL Synthesizer from Analog Devices of Norwood, Mass., USA. Subsequent to mixing, the signal is filtered by intermediate frequency filter 440 to define the signal bandwidth characteristics prior to digitization. Signal bandwidth characteristics of IF filter 440 are discussed herein below in association with FIGS. 6 and 7. Next, IF digitizer 442 receives the filtered signal and digitizes the signal to produce sampled data. IF digitizer functionality may be provided by a device such as the AD9864 IF Digitizing Subsystem from Analog Devices of Norwood, Mass., USA.

The sampled data may then be transferred, either directly or via controller 446, to a signal analyzer such as signal analyzer 450 of FIG. 4 for analysis such as the determination of plasma parameters. Oscillator 444 provides a reference oscillator for phase locked loop synthesizer 438 and IF digitizer 442. Controller 446 which controls IF digitizer 442 and other internal elements of signal processor 430 is included in signal processor 430. Clock 448, integrated with signal processor 430, provides a time base and time stamping for sampled data processed by signal processor 430.

Depending on the production process, signal analyzer 450 may require more additional processing to discriminate and further define frequency components with the bandwidth data sampled. Optional post processor 447 may be provided for that purpose. As depicted in the present figure, optional post processor 447 may be incorporated within controller 446 or alternatively configured between controller 446 and IF digitizer 442 as a separate component. In any case, optional post processor 447 may operate FFT, Goertzel algorithms or the like to, for instance, isolate specific one or more narrow bandwidth frequencies within the primary filter frequency bandwidth.

At times during the production process, changes in the intensity of plasma light emissions and/or primary modulated frequency or frequency range may require the signal processing parameters be actively configured from the current signal processing parameter for better analyzing the sampled data (on the other hand, it may be advantageous for the signal analyzer to concentrate on different wavelength frequencies at different stages of the production process). In either case, controller 446 receives configuration instruction from signal analyzer 450, which then actively configures various components within signal processor 430. For instance, changes in the intensity of plasma light emissions may result in signal analyzer 450 communicating to controller 446 the need for additional amplified/de-amplified by low noise amplifier 435. Controller 446 then sends the appropriate instructions to low noise amplifier 435. Alternatively, noise, aliasing or DC bias levels may change during the production process or there may be cases where the frequency of the modulated component of the emissions may drift slightly. In either case, signal analyzer 450 communicates this information to controller 446, which in turn actively communicates configuration instructions to one of both of filter 434 and IF digitizer 442 based on the information provided by signal analyzer 450. Additionally, signal processor 430, and/or controller 446 more specifically, may communicate control signals to optical filter 410 and/or optical sensor 420. For example, optical filter may be a series of optical filters on a controllable motorized optical filter wheel or may be another electro-optic element such as an electronically controlled polarizer which may be selected based upon analysis of signals by signal processor 430. Optical sensor 420, for example may be a photomultiplier tube assembly or other optical sensor with integral gain elements which may be controlled by controller 446.

FIG. 6 shows plot 600 of multiple filter functions configurable by IF filter 440 of FIG. 5, in accordance with an exemplary embodiment of the present invention. Filter functions 610, 620 and 630 are Gaussian filter functions of increasing widths. Using a configurable IF filter function, the signals processed by signal processor 430 may be varied to suit the needs of the plasma parameter measurement system and may be used to aid isolation process parameters indicative of the process state of the workpiece, the plasma environment and process reactor from each other. For example, narrow filter function 610 may be used to monitor a single frequency of the modulated light signal at its known RF power supply frequency. The use of a narrow filter function minimizes the computational and data analysis complexity for cases where the plasma frequency is not variable, and monitoring only the amplitude change of the fixed frequency modulated light signal is sufficient for determining plasma parameters.

Intermediate width filter function 620 may be used in cases where an RF power supply frequency is slightly variable and tracking of both frequency variation, as well as amplitude, is desired. Frequency variation may occur where the matching circuitry of the plasma etch reactor does not properly regulate the frequency or in cases where a power supply magnetron is defective. By monitoring both frequency variation and amplitude changes, it may be possible to isolate plasma parameters related to the workpiece from those resulting from instabilities or defects in the RF power supply.

Wide width filter function 630 may be utilized when the RF frequency is highly variable or when multiple frequencies exist in the modulated light signal. For example, when used to monitor a plasma etch reactor with frequencies of 13.56 and 2 MHz, a wide filter may be centered at the primary 13.56 MHz frequency but may also permit passing of the 13.56+/−2 MHz side lobes. The wide bandwidth data sampled after the wide filter may be further processed by FFT, Goertzel algorithms or the like to isolate with narrow bandwidth the primary 13.56 and 2 MHz frequencies (for instance by optional post processor 447). Capturing wide bandwidth signals and then post-processing may eliminate the need to scan the frequency between the desired values and effectively provides instantaneous collection of the multiple frequencies which is not possible if the frequency is scanned. Signal capture performed by this hybrid superheterodyne/FFT method also permits improved transient measurement of signals which may be useful for detection of arcing or other transient behaviors within a monitored plasma.

The filter functions shown in FIGS. 6 and 7 may not be indicative of the filter function of any specific process. Although shown as Gaussian filter functions, it should be recognized that many other filter functions of other mathematical forms may be used with the current invention. Each filter function has its own frequency roll-off which alters the behavior of the filter and, therefore, the information extracted from the modulated light signals. Examples of other filter functions include well known Chebyshev, Butterworth and Bessel filter functions.

FIG. 7 shows plot 700 of a comb filter function configurable by IF filter 440 of FIG. 5, in accordance with an exemplary embodiment of the present invention. Unlike the filter functions of FIG. 6, the exemplary comb filter function of FIG. 7 includes multiple passbands in the frequency spectrum. A comb filter may be especially useful for isolating harmonics of a modulation frequency from background signals. Although shown as having identically-shaped and evenly-spaced passbands, this functional form is not required. For example, a filter may be designed that omits the odd harmonic at the normalized frequency value of 3. A filter with multiple passbands may also be designed for use when monitoring modulated light from plasma etch reactor with multiple RF excitation frequencies (e.g., 2 and 60 MHz).

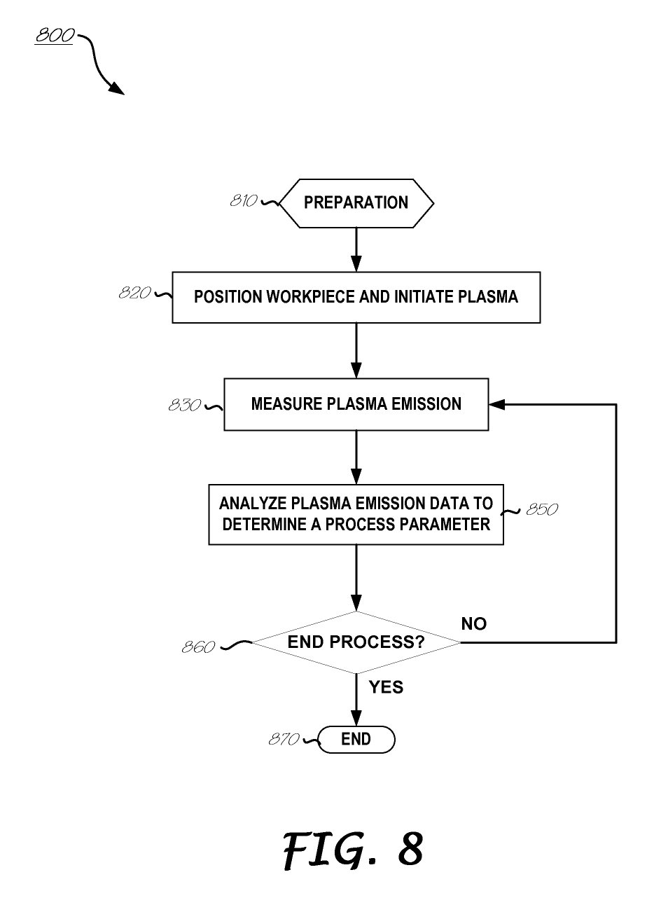

FIG. 8 shows a flow chart of process 800 for operating a plasma parameter measurement system, in accordance with an exemplary embodiment of the present invention. Process 800 begins with preparation step 810 wherein any necessary or desired setup, configuration (such as filtering, wavelength selection, etc. as discussed herein), supply, transport and/or installation of a measurement system are performed. Additionally, or optionally, power to a measurement system may be supplied during step 810, such as by activating a power switch or supplying external power. Upon completion of any preparatory activity, process 800 next advances to step 820 wherein a workpiece is positioned and plasma processing is initiated.

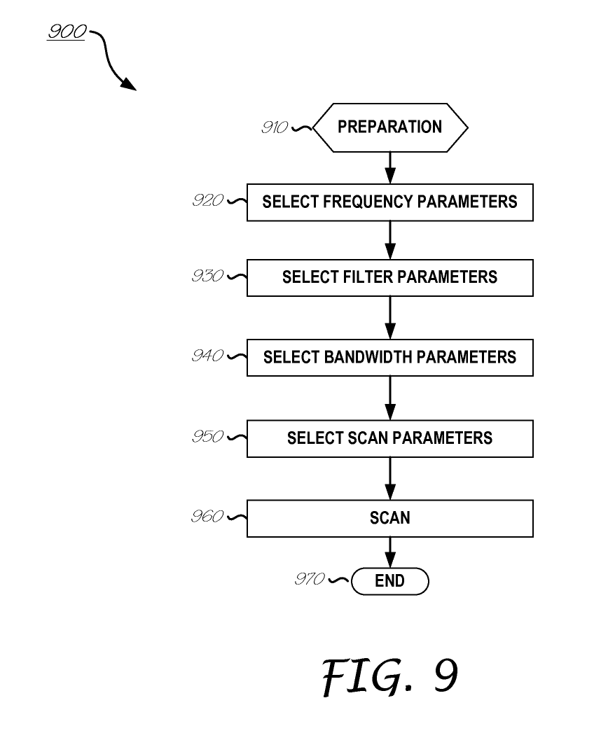

Once plasma processing has been initiated, process 800 advances to step 830 wherein measurement of the modulated light emitted by the plasma is performed using the plasma measurement system described herein. Initiation of measurement may, for example, be directed by a command sent from an associated plasma etch reactor to the measurement system. Details of this measurement step are described by process 900 of FIG. 9. Subsequent to step 830, plasma emission data is analyzed in step 850 to determine a process state of the workpiece, the plasma and/or the plasma etch reactor. Analysis may be performed, for example, by signal analyzer 450 of FIG. 4. Upon evaluation of the data, a decision is made in step 860 to either continue or terminate processing of the workpiece. If the decision is to NOT terminate processing then process 800 returns to monitoring step 830. If the decision is to terminate processing then process 800 advances to end step 870 where the plasma may be de-excited and the workpiece removed.

For the exemplary CF₄ etch process discussed above, measurement and analysis of plasma emission data may derive a time series of values indicative of the intensity of the 703.7 nm emission line of fluorine. This time series may include in temporal order: 1) initial transient values when the plasma is first initiated; 2) main etch values during the time that the bulk of the etching is performed; and 3) “endpoint” values indicative of a change in the etching. During times associated with the transient values and main etch, steps 850 and 860 may be ignored until a fixed time has elapsed or a recognizable feature of the time series is identified. During times associated with “endpoint” a signal analyzer may analyze the plasma emission data to determine a process parameter such as a threshold value or slope of the time series data. End process decision step 860 may form the decision to continue or terminate process 800 based upon comparing an instant threshold value to a predetermined threshold value such that when the instant threshold value falls below the predetermined threshold value, process 800 will be terminated.

If not configured for “endpoint” but for real-time process control, steps 850 and 860 may not be ignored during the main etch period and the signal analyzer may analyze the plasma emission data to determine a process parameter such as a slope of the time series. During the main etch period, it may be expected that the slope of the time series is near zero within some predetermined bounds (indicating that the etch rate and other factors affecting the etch are constant). In this scenario, step 860 may be modified or substituted to include one or more steps that include sending information to the plasma etch reactor indicating the constancy or variation of the time series. With this information the plasma etch reactor may then alter a process parameter, such as a gas flow rate or the value of the supplied RF power. Process monitoring of the time series values may indicate the stability of frequencies, intensity of modulated light and harmonics. These parameters may provide plasma parameter information at the wafer level as they are derived from the modulated light. The intensity values of the primary and driving frequencies and intensities of harmonic frequencies, including ratios of these intensity values, may provide parameters for radical density control and driving frequency control. These parameters may then be optimized by the plasma etch reactor controller or operator to determine if reactors are matched or operating outside normal conditions, in which case, the controller and/or operator may stop or alter the processing of workpieces. New plasma etch processes may cause damage to workpieces due to the high energy levels at the workpiece surface. To mitigate this potential damage, plasma etch reactors integrate pulsed plasma technologies with the ability to lower the ion energy levels to a few electronVolts (“eV”) by pulsing the duty cycle of the source and bias RF powers. In this relaxed plasma mode, the duration of the pulse effects the ion energy. The plasma parameter measurement systems described herein may be used to monitor the pulse duration and its effects on the driving frequency of the sheath modulation and harmonics. Used in this way, a plasma parameter measurement system may provide a method to correlate ion energy without the use of a Langmuir probe.

FIG. 9 shows a flow chart of process 900 detailing various aspects of the measurement sub-process illustrated as measuring step 830 of process 800 of FIG. 8, in accordance with an exemplary embodiment of the present invention. Process 900 begins with preparation step 910 wherein any necessary or desired setup, readiness/fault checking and/or configuration are performed. Additionally, or optionally, any preparation activities performed during step 910 may be excluded and performed as part of preparatory step 810 of process 800. After the completion of any preparatory activities, process 900 advances to step 920 where frequency parameters are selected or retrieved. Frequency parameters may be defined as a single frequency, a range of frequencies or a set of discrete frequencies at which measurement of a modulated light signal is desired. The frequency parameters may be predetermined and fixed, in which case said parameters are retrieved from memory or other storage, or may be variable and updatable for each measurement cycle, in which case said parameters are selected from a range of operable frequencies. When the frequency parameters are predetermined and fixed, step 920 may be ignored subsequent to an initial retrieval. Frequency parameters are used as inputs for a signal processor to determine which frequencies are scanned.

In steps 930, 940 and 950, filter parameters, bandwidth parameters and scan parameters respectively are selected or retrieved. In like manner with the frequency parameters, these additional parameters may be predetermined and fixed, in which case said parameters are retrieved from memory or other storage, or may be variable and updatable for each measurement cycle, in which case said parameters are selected from a range of operable parameter values. When the parameters are predetermined and fixed, steps 930, 940 and 950 may be ignored subsequent to an initial retrieval. These parameters are used as inputs for a signal processor to determine how signals at the frequencies to be scanned are modified.

Once all parameters required for measurement operation are selected or retrieved and set, process 900 advances to step 960 where a frequency scan of sampled data is collected. This scan may include scanning of a single frequency, multiple frequencies, a narrow range of frequencies or a wide range of frequencies as described above in association with FIGS. 4-7. After a frequency scan is completed, process 900 advances to step 970 where an individual measurement cycle is finished and data may be transferred to a signal analyzer for further evaluation and determination of plasma parameters and process state parameters.

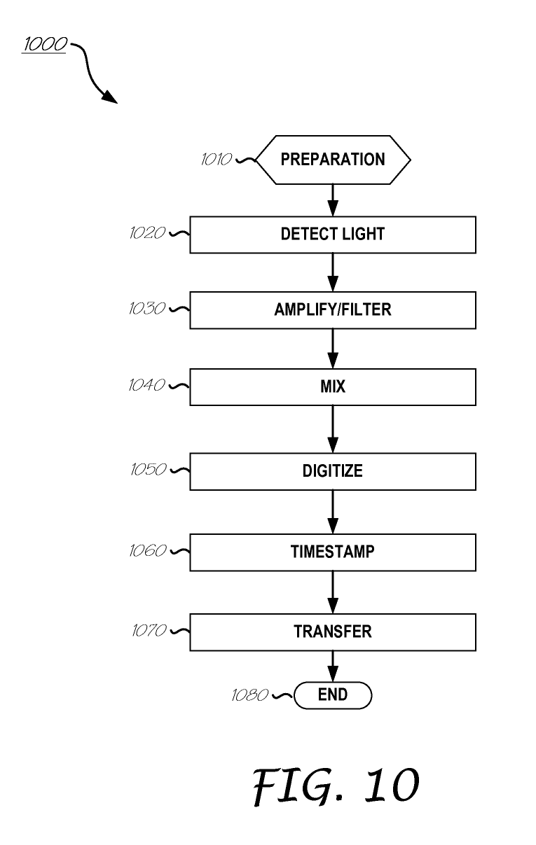

FIG. 10 shows a flow chart of process 1000 detailing scan step 960 of process 900 of FIG. 9, in accordance with an exemplary embodiment of the present invention. Process 1000 begins with preparation step 1010 wherein any necessary or desired setup, readiness/fault checking and/or configuration are performed. Additionally, or optionally, any preparation activities performed during step 1010 may be excluded and performed as part of preparatory step 810 of process 800 or as part of preparatory step 910 of process 900. After the completion of any preparatory activities, process 1000 next advances to step 1020 where light is detected using a predetermined and configured sensor, such as optical sensor 420 of FIG. 4. Subsequent to detection and conversion from light, an electrical signal may be amplified and/or filtered during step 1030, such as by filter 434 and/or amplifier 435 of FIG. 5.

After amplification and/or filtering the signal mixed during step 1040 to move the frequency of interest into range for IF filtering and digitization during step 1050, such as by IF filter 440 and IF digitizer 442 of FIG. 5. The output data from digitization step 1050 may then be time stamped during step 1060 and transferred during subsequent step 1070 to signal analyzer, such as signal analyzer 450 of FIG. 4 for determination/evaluation of plasma state, such as step 850 of process 800 of FIG. 8. Process 1000 ends with step 1080 where any resetting or reinitializing for a subsequent scan or additional frequencies with the same scan may be performed.

The changes described above, and others, may be made in the plasma parameter measurement systems described herein without departing from the scope hereof. For example, although certain examples are described in association with silicon wafer etching equipment, it may be understood that the plasma parameter measurement systems described herein may be adapted to other types of processing equipment such as semiconductor deposition equipment (chemical vapor deposition (“CVD”), physical vapor deposition (“PVD”) and their derivatives), wafer implant monitoring, semiconductor wafer resist ashing, or any application where plasma parameter measurement may be required including non-silicon based materials. Furthermore, although certain embodiments discussed herein describe the measurement of modulated light emitted from plasma, it should be understood that independently or in association with these measurements, other signals such a gas pressures and flow and direct monitoring of the RF power supply or RF field may be monitored.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

The exemplary embodiments described above were selected and described in order to best explain the principles of the invention and the practical application, and to enable others of ordinary skill in the art to understand the invention for various embodiments with various modifications as are suited to the particular use contemplated. The particular embodiments described above are in no way intended to limit the scope of the present invention, as it may be practiced in a number of variations and environments without departing from the scope and intent of the invention. Thus, the present invention is not intended to be limited to the embodiment shown, but is to be accorded the widest scope consistent with the principles and features described herein.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A plasma parameter measurement system for deriving at least one parameter from a modulated light component emitted by a plasma, comprising a plasma light detector for detecting plasma light emissions being generated from the plasma, an optical sensor for converting the detected plasma light to a light signal, a signal processor preparing the light signal for analysis and a signal analyzer for determining at least one parameter from the processed extracted modulated signal, wherein the signal processor comprises:
a superheterodyne assembly for receiving the light signal and a reference signal at an intermediating frequency and mixing the light signal and the reference signal to produce a superheterodyned signal at a down-converted intermediate frequency;
an intermediating frequency filter for filtering the superheterodyned signal across one or more bandwidths relevant to the at least one process state parameter; and
an intermediating frequency digitizer for digitizing the filtered superheterodyned signal at a sample rate.

2. The plasma parameter measurement system as in claim 1, wherein the signal processor further comprises:
a conditioning filter for filtering a passband of frequencies of the light signal; and
a low noise amplifier for altering a level of intensity of the light signal.

3. The plasma parameter measurement system as in claim 1, wherein the superheterodyne assembly further comprises:
a reference oscillator for generating a reference frequency; and
a phase locked loop synthesizer for locking a phase and frequency of the reference signal at the intermediate frequency based on the reference frequency.

4. The plasma parameter measurement system as in claim 1, wherein the intermediating frequency filter further comprises:
a filtering function of increasing spectral widths for filtering passbands of frequencies of the superheterodyned signal.

5. The plasma parameter measurement system as in claim 1, wherein the intermediating frequency filter further comprises:
a comb filtering function for filtering multiple passbands of frequencies of the superheterodyned signal.

6. The plasma parameter measurement system as in claim 1, wherein the intermediating frequency filter further comprises:
a comb filtering function for filtering multiple passbands of frequencies of the superheterodyned signal; and
a filtering function of increasing widths for the filtering multiple passbands frequencies.

7. The plasma parameter measurement system as in claim 1, wherein the signal processor further comprises:
a controller for controlling the sample rate of the intermediating frequency digitizer.

8. The plasma parameter measurement system as in claim 2, wherein the signal processor further comprises:
a controller for controlling the passband of frequencies of the light signal of the conditioning filter.

9. The plasma parameter measurement system as in claim 2, wherein the signal processor further comprises:
a controller for controlling the level of intensity of the light signal of the low noise amplifier.

10. The plasma parameter measurement system as in claim 1, wherein the signal processor further comprises:
a post processor for processing the filtered superheterodyned signal.

11. The plasma parameter measurement system as in claim 1, wherein the post processor further comprises:
a Fast Fourier Transform for isolating bandwidths within filtered superheterodyned signal.

12. The plasma parameter measurement system as in claim 1, wherein the post processor further comprises:
Goertzel algorithms for isolating bandwidths within filtered superheterodyned signal.
